(19) United States
(12) Patent Application Publication
(10) Pub. No.: US 2009/0087289 A1
(43) Pub. Date: Apr. 2, 2009

(54) Structure for storing a substrate and semiconductor manufacturing apparatus

(75) Inventor: Shin Osada, Nirasaki-shi (JP)

Correspondence Address: MASUVALLEY & PARTNERS, 8765 AERO DRIVE, SUITE 312, SAN DIEGO, CA, 92123, US

(73) Assignee: TOKYO ELECTRON LIMITED, Minato-ku (JP)

(21) Appl. No.: 12/284,095

(22) Filed: Sep. 17, 2008

(30) Foreign Application Priority Data
Sep. 27, 2007 (JP) 2007-251692

(51) Int. Cl. B65H 1/04; B65G 1/12

(52) U.S. Cl. 414/223.01; 414/298

(57) ABSTRACT

The present invention provides a structure for storing a substrate that can be downsized compared to conventional techniques and is capable of suppressing an increase in footprint. The structure for storing a substrate pertaining to the present invention includes a holding section for holding a substrate horizontally, an inner component positioned around the holding section, which has a loading and unloading section for loading and unloading the substrate from the holding section in a horizontal direction, and an outer component positioned around the inner component, which has an opening corresponding to the loading and unloading section, wherein the inner component and the outer component are able to rotate independently of each other and a rotation axis of the inner component and a rotation axis of the outer component are orthogonal to a face of the substrate.

### TECHNICAL FIELD

The present invention relates to a structure for storing a plurality of disk-shaped substrates and a semiconductor manufacturing apparatus.

### BACKGROUND OF THE INVENTION

Conventionally, it is known in the field of semiconductor manufacturing that a predetermined treatment, such as a film forming treatment or etching treatment is applied to a semiconductor wafer, that is, a disk-shaped substrate. Further, in the treatment described above, a dummy wafer, that is a disk-shaped substrate, may be used as needed to adjust conditions necessary to treat the regular semiconductor wafer, or for cleaning to remove deposits accumulated in a treatment chamber.

As such a semiconductor manufacturing apparatus, a semiconductor manufacturing apparatus provided with a treatment section for performing a predetermined treatment on a semiconductor wafer, a placing section for placing a cassette or hoop storing a plurality of semiconductor wafers, and a loader section having a transferring structure for transferring the semiconductor wafers between the cassette or hoop and the treatment section, has been known (for example, refer to Japanese Unexamined Published Patent Application No. 2005-310985).

Further, corrosive gasses may be used to perform, for example, etching treatment in the semiconductor manufacturing apparatus described above. In such a case, the corrosive gas absorbed on the semiconductor wafer is separated and may corrode the peripheral devices or negatively affect the other unprocessed semiconductor wafers when the processed semiconductor wafer is immediately returned to the cassette or hoop. For this reason, the corrosive gas is removed by connecting the structure for storing a substrate (purge storage) to the loader section, temporarily placing the processed semiconductor wafer and exhausting. Further, in a case when the dummy wafer as described above is used, the structure for storing a substrate (dummy storage) storing the dummy wafer may be connected to the loader section.

When the apparatus is used by connecting a structure for storing a substrate, such as a purge storage or dummy storage, to the loader section, there has been an issue of increasing the footprint of the entire semiconductor manufacturing apparatus. Especially in a case of the purge storage, it is necessary to install a large exhaust system for exhausting acid to prevent the corrosive gas from leaking to the loader section. For this reason, the size of the entire purge storage increases, which results in an increase of the footprint significantly.

The present invention has been made considering the above situation to provide a structure for storing a substrate and a semiconductor manufacturing apparatus that are capable of downsizing the structure for storing a substrate compared to the conventional technique, and suppressing the increase of the footprint.

### SUMMARY OF THE INVENTION

A structure for storing a substrate pertaining to the present invention includes a holding section for holding a substrate horizontally.

An inner component positioned around the holding section, which has a loading and unloading section for loading and unloading the substrate from the holding section in a horizontal direction and an outer component positioned around the inner component, which has an opening corresponding to the loading and unloading section, wherein the inner component and the outer component are able to rotate independently of each other and a rotation axis of the inner component and a rotation axis of the outer component are orthogonal to a face of the substrate.

In the structure for storing a substrate pertaining to the present invention, the holding section may include a holding structure, which holds a plurality of substrates in a shelf form.

In the structure for storing a substrate pertaining to the present invention, the inner component may have a half cylinder shape.

In the structure for storing a substrate pertaining to the present invention, the rotation axis of the inner component may be the same rotation axis as the outer component.

In the structure for storing a substrate pertaining to the present invention, the inner component and the outer component are rotatable and configured to make a first configuration, that the loading and unloading section is covered with the outer component, and a second configuration, that the loading and unloading section is not covered with the outer component, by rotating independently of each other.

The structure for storing a substrate pertaining to the present invention may include an exhaust system for exhausting the space where the substrates are stored.

The structure for storing a substrate pertaining to the present invention may further include an outside cover positioned outside of the outer component, in which the outer component is provided so as to rotate inside, wherein the outside cover has an opening of the outside cover corresponding to the loading and unloading section and an exhaust port connected to the exhausting system.

In the structure for storing a substrate pertaining to the present invention, the outer component contains a plurality of openings, which are separated vertically, with opening directions of each opening different.

In the structure for storing a substrate pertaining to the present invention, the substrate may be in a disk shape.

A semiconductor manufacturing apparatus pertaining to the present invention includes a processing section for performing a predetermined treatment to a substrate in disk shape and a loader section including a placing section for placing a cassette or hoop, which stores a plurality of the substrates, and a transfer system for carrying the substrate between the cassette or the hoop and the processing section, wherein the loader section includes the structure for storing a substrate and is configured to load and unload the substrate by the transfer system described above.

According to the present invention, the structure for storing a substrate can be downsized compared to the conventional technique thereby the structure for storing a substrate and semiconductor manufacturing apparatus that suppresses an increase in footprint is provided.

### BRIEF DESCRIPTION OF THE DRAWINGS

FIG. 1 illustrates a configuration of a structure for storing a substrate pertaining to an embodiment of the present invention.

FIG. 2 illustrates a configuration of a structure for storing a substrate pertaining to another embodiment of the present invention.

FIG. 3 illustrates a configuration of a structure for storing a substrate pertaining to another embodiment of the present invention.

FIG. 4 illustrates a configuration of a semiconductor manufacturing apparatus pertaining to an embodiment of the present invention.

### DETAILED DESCRIPTION OF INVENTION

Embodiments of the present invention will be explained in detail referring to figures.

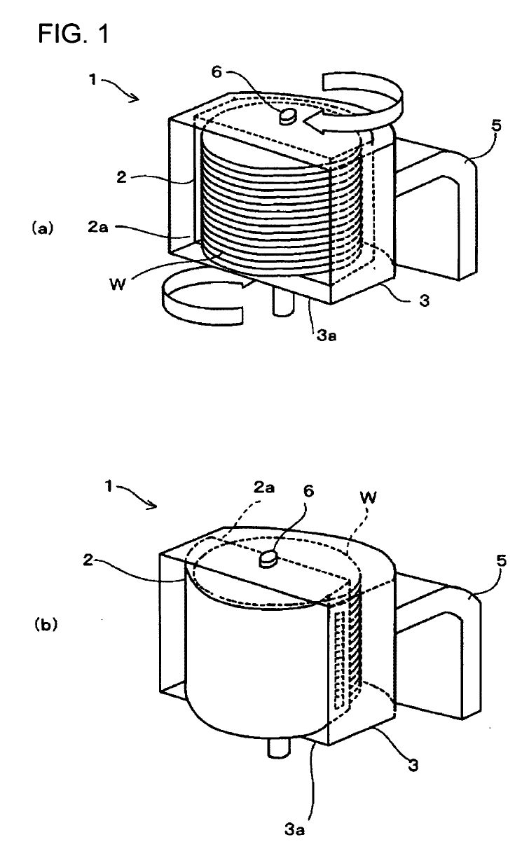

FIG. 1 illustrates a configuration of a structure for storing a substrate pertaining to an embodiment of the present invention. A structure for storing a substrate 1 shown in FIG. 1 has an inner component 2. An outer shape of this inner component 2 is formed in a half cylinder shape. Inside of the half cylinder, provided is a holding section (not shown) in a slot form for supporting a plurality of (in this embodiment 25) disk-shaped semiconductor wafers W (or dummy wafers) in a shelf form with spacing. Because the entire inner component 2 is in the half cylinder shape in this way, on a side in which there is no half cylinder structure of the inner component 2 (opening end side), is a loading and unloading section 2a for loading and unloading the semiconductor wafer or the like.

On the outside of the inner component 2, provided is an outer component 3, which has an overall shape of a substantial half cylinder. This outer component 3 has an inner diameter slightly larger than the outer diameter of the inner component 2 so as to externally position around the inner component 2, and is coaxially located with the inner component 2. And the inner component 2 and outer component 3 are rotatable relative to a vertical axis 6. In this embodiment, the outer component 3 is fixed and the inner component 2 is rotatable. The semiconductor wafers can be loaded or unloaded in the inner component 2 when the opening section 3a (side without the half cylinder structure of the outer component 3) and the loading unloading section 2a of the inner component 2 are aligned as shown in FIG. 1(a) (a state in which the loading and unloading section is opened). And, by rotating the inner component 2 180 degrees from this state, the loading and unloading section 2a of the inner component 2 is covered by the outer component 3 (a closing state of loading and unloading section 2a) as shown in FIG. 1(b).

On the back side of the outer component 3, an exhaust system 5 is connected so as to exhaust from the structure for storing a substrate 1 when the loading and unloading section 2a is closed as described above. In this way, by exhausting from the structure for storing a substrate 1 while the loading and unloading section 2a is closed, a corrosive gas absorbed on the semiconductor wafer W can be suppressed from leaking externally from the loading and unloading section 2a. Therefore, for example, the configuration of the exhaust system can be downsized (a diameter of the pipe for the exhaust system) compared to conventional techniques, and the entire structure for storing a substrate 1 can be downsized. Further, because the loading and unloading section 2a is configured to open and close by relatively rotating dual half cylinder bodies (inner component 2 and outer component 3), the configuration is simplified and the number of components can be reduced, thereby the entire structure for storing a substrate 1 can be downsized. Consequently, the increase in footprint can be suppressed.

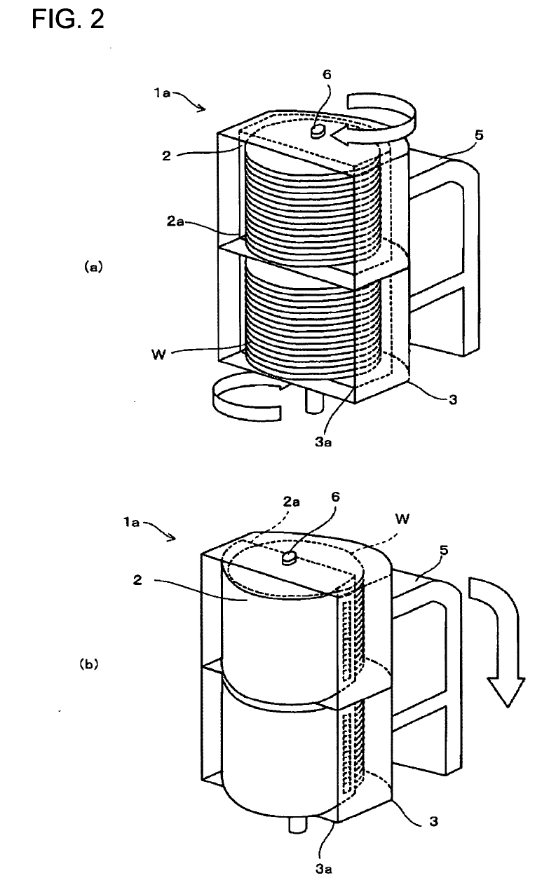

FIG. 2 illustrates a configuration of the structure for storing a substrate la in another embodiment. The same reference numbers are used to the portions corresponding to the embodiment shown in FIG. 1. In this structure for storing a substrate 1a of the embodiment, a plurality of structures for storing a substrate 1 described above (two in the FIG. 2) is arranged in vertical direction. Therefore, 25 on top, 25 on bottom, with a total of 50 semiconductor wafers can be stored.

In a case of the structure for storing a substrate la of this embodiment, the inner component 2 may be formed separately into an upper section and lower section, or integrated into a unit. When the inner component 2 is formed separately into the upper section and lower section and each of the sections is configured to rotate independently by the rotation system provided on each of the sections, opening and closing of the loading and unloading section 2a can be performed separately for the upper section and the lower section. In addition, FIG. 2(a) illustrates an opening state of the loading and unloading section 2a and FIG. 2(b) illustrates a closing state of the loading and unloading section 2a. The outer component 3 may also be formed separately into an upper section and a lower section, or integrated into a unit.

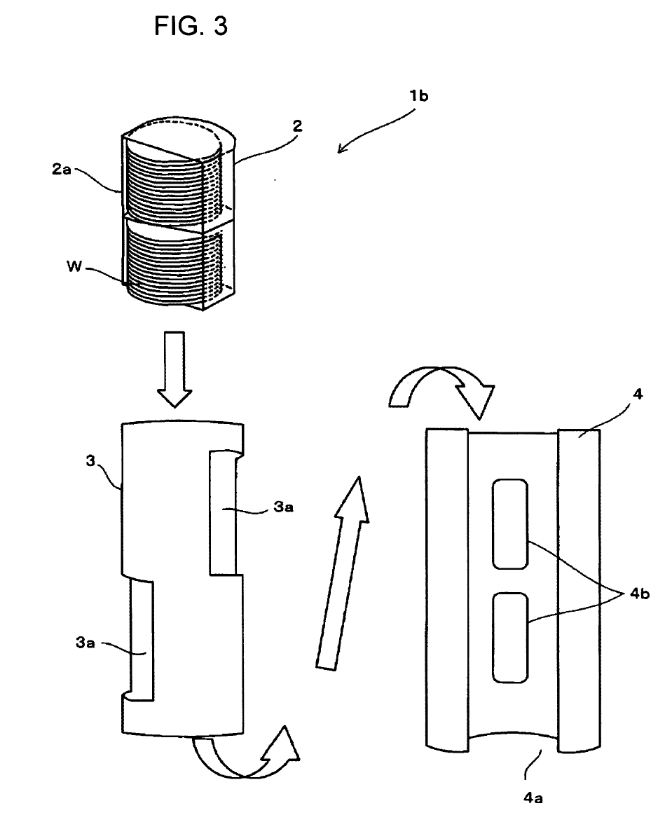

FIG. 3 is an exploded perspective view illustrating a configuration of a structure for storing a substrate 1b pertaining to another embodiment. The structure for storing a substrate 1b in this embodiment further includes an outside cover 4 on the outside of the structure for storing a substrate la in the two-tiered structure shown in FIG. 2. The overall shape of the outside cover 4 is in a substantially half cylinder. And the cover opening section 4a side without the cylinder structure and the loading and unloading section 2a of the inner component 2 are arranged to face the same direction, and an exhaust port 4b is formed on the back face side of the outside cover 4 to connect the exhaust system.

Further, this structure for storing a substrate 1b is configured to rotate the outer component 3, thereby the semiconductor wafer or the like can be loaded and unloaded into the inner component 2 when the opening section 3a of the outer component 3 is aligned to the loading and unloading section 2a of the inner component 2, and then the loading and unloading section 2a of the inner component 2 is closed when the outer component 3 is rotated 180 degrees from the aligned state. In this way, by configuring to rotate the outer component 3, application of vibration to the semiconductor wafer W or the like can be suppressed when opening and closing the loading and unloading section 2a.

Further, in a case of the structure for storing a substrate lb shown in FIG. 3, the opening 3a of the outer component 3 is arranged such that the upper section and lower section face opposite from each other. In this way, when the upper loading and unloading section 2a is opened, the lower loading and unloading section 2a is closed, and when the upper loading and unloading section 2a is closed, the lower loading and unloading section 2a is opened. Contrarily, when the opening section 3a of the outer component 3 is arranged such that the upper section and lower section face the same direction, the opening and closing states of the upper loading and unloading section 2a and lower loading and unloading section 2a can be the same. In addition, the opening and closing states of the upper loading and unloading section 2a and lower loading and unloading section 2a may be configured separately by forming the external component 3 into separate upper and lower section with each of the sections independently rotatable.

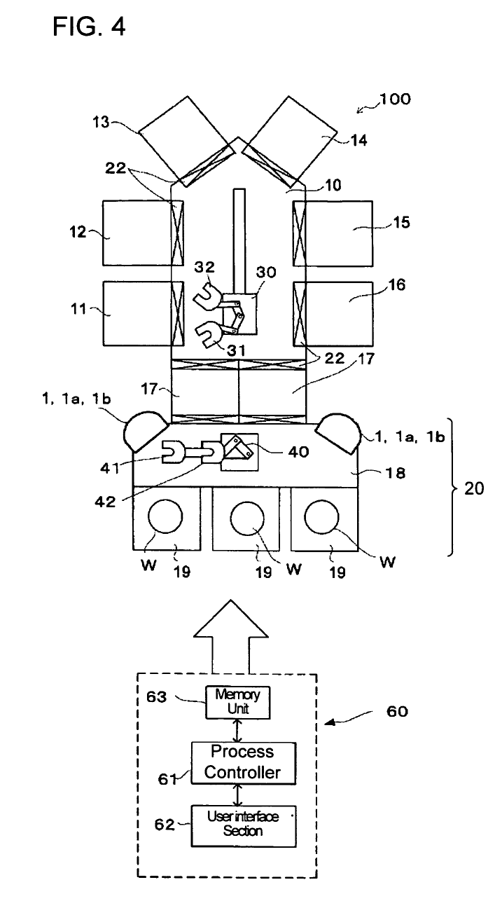

FIG. 4 illustrates an overall configuration of the semiconductor manufacturing apparatus 100 in which any of the structures for storing a substrate 1, 1a or 1b is provided. On the center of the semiconductor manufacturing apparatus 100, a vacuum transfer chamber 10 is provided. In the surrounding area, a plurality of vacuum processing chambers (six in this embodiment) 11 to 16 is arranged around the vacuum transferring chamber 10.

On a front side of the vacuum transfer chamber 10 (lower side in the figure), two load lock chambers 17 are provided. And a loader section 20 is further provided on a front side of these load lock chamber 17 (lower side in the figure). On the loader section 20, a transfer chamber 18 is provided for transferring the semiconductor wafer W (or dummy wafer). Further, a plurality of placing sections 19 (three in FIG. 4) for arranging a cassette or hoop which is capable of storing a plurality of wafers W, are provided on the front side of the transferring chamber 18 (lower side of the figure). In addition, on the side of the load lock chamber 17, one of the structures for storing a substrate 1, 1a or 1b is installed.

Between the load lock chamber 17 and transfer chamber 18, between the load lock chamber 17 and vacuum transfer chamber 10, and between the vacuum transfer chamber 10 and vacuum processing chambers 11 to 16, a gate valve 22 is provided respectively to hermitically close and open these chambers. Further, a vacuum transfer system 30 is provided in the vacuum transfer chamber 10. This vacuum transfer system 30 has a first pick 31 and second pick 32 so as to support two semiconductor wafers W, and is configured to load and unload the semiconductor wafer W from/to each of the vacuum process chambers 11 to 16 and load lock chamber 17.

Further, a transfer system in the air 40 is provided in the transfer chamber 18. This transfer system in the air 40 has a first pick 41 and second pick 42 so as to support two semiconductor wafers W. The transfer system in the air 40 is configured to load and unload the semiconductor wafer W and dummy wafer to each cassette or hoop placed on the placing section 19, load lock chamber 17, and structures for storing a substrate 1, 1a and 1b.

Overall operations of the semiconductor manufacturing apparatus 100 configured as described above are controlled by a control section 60. This control section 60 is provided with a process controller 61 having a CPU for controlling each part of the semiconductor manufacturing apparatus 100, user interface section 62 and memory unit 63.

The user interface section 62 is configured from a keyboard for inputting commands to manage the semiconductor manufacturing apparatus 100 by a process manager, and a display to visualize the operating condition of the semiconductor manufacturing apparatus 100.

The memory unit 63 stores a control program (software) for realizing various processes executed in the semiconductor manufacturing apparatus 100 by the control of the process controller 61, or a recipe in which process condition data or the like is stored. And, the process controller 61 executes various recipes called from the memory unit 63 according instructions from the user interface section 62, thereby an intended process is performed in the semiconductor manufacturing apparatus 100 under the control of the process controller 61. Further, the recipe, such as the control program or process condition data, may be in a form of a computer readable storage medium (for example, hard disk, CD, flexible disk, or semiconductor memory), or in a form that is “online,” for example by transmitting from another device through a dedicated line as needed.

In the semiconductor manufacturing apparatus 100 configured as described above, because loader section 20 is provided with the structures for storing a substrate 1, 1a and 1b that are decreased in size, the size of the entire semiconductor manufacturing apparatus 100 can be decreased compared to the conventional techniques and the increase in footprint can be suppressed. Further, the structures for storing a substrate 1, 1a, and 1b are exhausted while the loading and unloading section 2a of the structures for storing a substrate 1, 1a and 1b are closed, thus the negative effects caused from the corrosive gases or the like absorbed on the semiconductor wafer 1 leaking to the loader section 20 can be suppressed.

What is claimed is:

1. An apparatus for storing a substrate, comprising:
a holding section for holding a substrate substantially horizontally;
an inner component positioned around the holding section, which has a loading and unloading section for loading and unloading the substrate from the holding section in a substantially horizontal direction; and
an outer component positioned around the inner component, which has an opening corresponding to the loading and unloading section;
wherein the inner component and the outer component are able to rotate independently of each other and a rotation axis of the inner component and a rotation axis of the outer component are orthogonal to a face of the substrate.

2. The apparatus of claim 1, wherein the holding section includes a holding structure, which holds a plurality of substrates, with a face of each substrate substantially parallel.

3. The apparatus of claim 2, wherein the inner component comprises a shape of a half cylinder.

4. The apparatus of claim 3, wherein a rotation axis of the inner component is the same as a rotation axis of the outer component.

5. The apparatus of claim 4, wherein the inner component and the outer component are rotatable and arrangable in a first configuration where the loading and unloading sections are covered by the outer component, and also in a second configuration where the loading and unloading sections are not covered by the outer component.

6. The apparatus of claim 5, further comprising an exhaust system for exhausting an inner space that stores the substrate.

7. The apparatus of claim 6, further comprising an outside cover positioned outside of the outer component, in which the outer component can rotate inside;
wherein the outside cover includes an opening section that corresponds to the loading and unloading sections and an exhaust port connected to the exhaust system.

8. The apparatus of claim 7, wherein the outer component includes a plurality of openings, which are positioned substantially vertically, where an opening direction of each of the plurality of openings is different.

9. The apparatus of claim 8, wherein one opening direction is opposite to another opening direction.

10. The apparatus of claim 9, wherein the substrate comprises a disk shape.

11. A semiconductor manufacturing apparatus comprising;
a processing section for performing a treatment to a substrate; and
a loader area including a placing section for receiving a cassette that stores the substrate, and a transfer system for carrying the substrate between the cassette and the processing section;
wherein the cassette comprises:
a holding section for holding the substrate substantially horizontally;
an inner component positioned around the holding section, which has a loading and unloading section for loading and unloading the substrate from the holding section in a substantially horizontal direction; and
an outer component positioned around the inner component, which has an opening corresponding to the loading and unloading section;
wherein the inner component and the outer component are able to rotate independently of each other and a rotation axis of the inner component and a rotation axis of the outer component are orthogonal to a face of the substrate.
